(19) United States
(12) Patent Application Publication
(10) Pub. No.: US 2015/0154528 A1
(43) Pub. Date: Jun. 4, 2015

(54) TASK MANAGER FOR HEALTHCARE PROVIDERS

(71) Applicant: ZocDoc, Inc., New York, NY (US)

(72) Inventor: Oliver D. KHARRAZ TAVAKOL, Brooklyn, NY (US)

(73) Assignee: ZocDoc, Inc., New York, NY (US)

(21) Appl. No.: 14/094,177

(22) Filed: Dec. 2, 2013

(51) Int. Cl. G06Q 10/06; G06Q 50/22

(52) U.S. Cl. CPC G06Q 10/063114; G06Q 50/22

(57) ABSTRACT

System and method for generating and managing tasks relating to patient office visits with healthcare providers. A priority is assigned to each task based on a desired patient experience or provider efficiency. A set of prioritized tasks is generated, assigned to a user for completion, and dynamically displayed on an interactive user interface to enable the assigned user to access and manage the prioritized tasks and accept user responses for completing the tasks. The user responses are monitored and processed to detect the timing, content or lack of user responses. The related tasks of a workflow may be assigned to users across different provider groups, and their cumulative responses monitored and synchronized for timely completion. At regular or varying time intervals, which intervals can be adjusted based on a user's response history or other factors, the user receives a continuously updated and prioritized list of tasks to enable more efficient completion of the tasks. The system is configured to learn over time which priorities, presentation forms and assigned users best achieve a timely completion of such tasks.

### FIELD OF THE INVENTION

The present invention relates to a system and method for task management in the delivery of healthcare provider services.

### BACKGROUND

It is generally recognized that the delivery of healthcare services has not undergone the same efficiency improvements achieved in other industries. Patients continue to be frustrated with delays in locating and securing timely appointments with suitable healthcare providers, waiting room delays as support staff struggle to get patients in and out of their scheduled appointments on time, and delays receiving on-going treatment or diagnosis (e.g., securing a referral to a specialist or completing lab tests required for diagnosis). Patients also become frustrated when repeatedly asked to provide the same contact, insurance and medical history information on every visit with every provider. Likewise, the healthcare provider's office support staff is frustrated with the burden of collecting such information before patients can be moved to examining rooms at the scheduled appointment times. Often the staff has to arrange for one patient to be seen by multiple individuals in different rooms and departments (e.g., physicians, physician assistants, blood technicians, X-ray technicians, etc.) in a single day. This is all occurring while the support staff struggle to accommodate new and unscheduled appointments, along with cancellations and “no-shows”. Physicians become frustrated when they are left waiting for the next patient because, invariably, some step in the process is overlooked, delayed or rearranged to accommodate unforeseen events and other emergencies.

Therefore, there exists an unfilled need for a task management system and method that facilitates the more efficient delivery of healthcare provider support services typically encountered during an office visit. There also exists an unfilled need for such a system and method that reduces the labor costs associated with handling these tasks compared with prior art systems.

### SUMMARY OF THE INVENTION

In view of the foregoing, an advantage of the present invention is in providing a healthcare task management system and method that facilitates the assignment and completion of tasks associated with the delivery of patient care in a provider's office.

Another advantage of the present invention is in providing a system and method that reduces the labor costs associated with such delivery of services.

The present invention removes the burden from the support staff of understanding the tradeoffs between different tasks and their priority. It also limits the distraction and stress imposed on the support staff from many different sources (phone calls, email, waiting patients and physicians, etc.) that compete for their attention and interfere with their ability to work efficiently.

In various embodiments, the invention enables a staff person to complete each task with a minimum number of steps, inputs and effort by providing a designated workflow and pre-existing data, rather than requiring the staff member to complete each task from scratch.

In one embodiment, a system is provided that can track and guide each staff member to timely completion of tasks. The system can also learn by monitoring staff responses and determining which practices are best to achieve timely completion of a continuously evolving range of tasks. This knowledge base can be applied on an individual user basis, provider group wide basis, or on a system wide basis across different practice groups.

In one embodiment of the invention, a rules engine processes appointment data relating to patient office visits with healthcare providers at provider facilities, wherein the processing generates tasks associated with such visits. A priority is assigned to each task based on a desired patient experience or provider efficiency. A set of prioritized tasks is generated, assigned to a user for completion, and displayed on an interactive user interface to enable the assigned user to access and manage the prioritized tasks and to accept user responses for completing the tasks. The user responses are monitored and processed to detect the timing, content or lack of user responses. Based on the processed responses, the set of prioritized tasks is modified and the modified set displayed on the user interface. Thus, at regular or varying time intervals, which intervals can be adjusted based on a user's response history or other factors, the user receives a continuously updated and prioritized list of tasks to enable more efficient completion of the tasks. The rules engine is configured to learn over time which priorities, presentation forms and assigned users best achieve a timely completion of such tasks.

In another embodiment of the invention, a healthcare task management system is provided that includes a processor adapted to electronically communicate with a storage module, a task management module, and an interface module. The storage module stores appointment, patient, provider and task data relating to patient office visits with healthcare providers. The task management module comprises a rules engine for processing the stored data, at regular or varying time intervals, to generate a set of prioritized tasks for completion by an assigned user. The module includes a task generator that associates stored patient, provider and appointment data with related tasks to facilitate completion (e.g., partial completion) of the tasks, and assigns each task one of multiple task types and a task priority. A task assignment and dispatch module generates a set of prioritized tasks for an associated provider, for completion by the assigned user. An interface module provides an interactive user display of the set of prioritized tasks, arranged by task type and priority, enabling the assigned user to access and manage the prioritized tasks and accept user responses for completion of each task. A task monitor is configured to monitor, receive and process the user responses by detecting the timing, content or lack of user responses, and updates the stored data based on the processed responses. Then, at each subsequent time interval, the task management module processes the updated stored data to generate an updated set of prioritized tasks for display to the assigned user, by adding uncompleted tasks and removing completed tasks.

In accordance with one embodiment of the invention, a computer-implemented method is provided comprising:

selecting, via a processor, stored task data identifying multiple related tasks of a workflow for completion by multiple healthcare providers from different provider groups;

applying process logic and rules data for assigning different related tasks of the workflow to different assigned users each associated with a different one of the multiple healthcare providers;

applying process logic and rules data for generating a prioritized set of assigned tasks for each respective assigned user;

communicating each prioritized task set to the respective assigned user of the associated healthcare provider via an interactive electronic display that allows the assigned user to view the prioritized set and input responses for completing each assigned task;

monitoring the cumulative responses of the assigned users to determine completion of the related tasks of the workflow;

deleting from the prioritized task sets, tasks that are determined completed; and

dynamically reprioritizing the task sets for each of the assigned users based on the monitored user responses and deleted tasks and communicating the updated reprioritized task sets to the respective assigned users of the associated healthcare providers.

In one embodiment, the monitoring step comprises detecting the timing, content or lack of user response.

In one embodiment, the method includes reassigning tasks to one or more other users based on timeliness of user response or determined task completion.

In one embodiment, the assigning step determines which tasks are assigned to which user based on previously monitored user responses.

In one embodiment, the stored task data includes different versions of a task and the method of assigning assigns different task versions to different users based on previously monitored responses of the respective user.

In one embodiment, the different versions include a different designated response time or completion time.

In one embodiment, the method includes assigning each task one of multiple task types and task priorities, and displaying the prioritized set of tasks of the respective user arranged by task type and priority.

In one embodiment, the method includes generating and displaying a standard set of user responses for selection by different users.

In one embodiment, the method includes comparing user selection of standard responses across multiple task types.

In one embodiment, the assigning step includes assigning a different task priority or assigning a different user based on the compared user selection of standard responses.

In one embodiment, the method includes analyzing the monitored responses of different assigned users to identify differences in timeliness or completion.

In one embodiment, the analyzing step comprises comparing the responses of users associated with providers in the same provider group.

In one embodiment, the analyzing step comprises comparing the responses of users associated with providers in different provider groups.

In one embodiment, the method includes for at least one prior stored task of a workflow, modifying the prior stored task based on a monitored user response, and storing the modified task.

In one embodiment, the method includes analyzing the monitored user responses by comparing user responses to the prior and modified tasks for timeliness or completion.

In one embodiment, the analyzing step comprises comparing responses of the same user to the prior and modified tasks for timeliness or completion and associating one of the prior and modified tasks for future assignment to the same user.

In one embodiment, the analyzing step comprises comparing responses of different users to the prior and modified tasks for timeliness or completion and associating one of the prior and modified tasks for future assignment to users.

In one embodiment, the analyzing step comprises comparing user responses to the prior and modified tasks across different provider groups.

In one embodiment, the analyzing step comprises selecting, based upon the compared user responses, from among the prior and modified tasks to generate and store a set of related tasks of a workflow for future assignment across different provider groups.

In one embodiment, the prioritized set of tasks are displayed in order of relative priority of time sensitivity or user-specific completion time.

In accordance with one embodiment of the invention, a computer-readable storage device is provided storing instructions which, when executed by a computing device, cause the computing device to perform a method comprising:

selecting, stored task data identifying multiple related tasks of a workflow for completion by multiple healthcare providers from different provider groups;

assigning different related tasks of the workflow to different assigned users each associated with a different one of the multiple healthcare providers;

generating a prioritized set of assigned tasks for each respective assigned user;

communicating each prioritized task set to the respective assigned user of the associated healthcare provider via an interactive electronic display that allows the assigned user to view the prioritized set and input responses for completing each assigned task;

monitoring the cumulative responses of the assigned users to determine completion of the related tasks of the workflow;

deleting from the prioritized task sets, tasks that are determined completed; and

dynamically reprioritizing the task sets for each of the assigned users based on the monitored user responses and deleted tasks and communicating the updated reprioritized task sets to the respective assigned users of the associated healthcare providers.

In accordance with one embodiment of the invention, a healthcare provider task management system is provided comprising:

a processor adapted to electronically communicate with a storage module, a task management module, and an interface module;
the storage module storing appointment, patient, provider and task data relating to patient office visits with healthcare providers;
the task management module comprising a rules engine for processing the stored data, at regular or varying time intervals, to generate a set of prioritized tasks for an associated provider for completion by an assigned user, including:
a task generator for processing the stored data to generate tasks required for completion, including associating stored patient, provider and appointment data with a related task to facilitate completion of the task, and assigning each task one of multiple task types and a task priority;
a task assignment and dispatch module configured to generate a set of prioritized tasks for an associated provider for completion by an assigned user;
the interface module being configured to generate an interactive electronic user interface for displaying the set of prioritized tasks, arranged by task type and priority, to enable the assigned user to access and manage the prioritized tasks, and for accepting user responses for completion of each task;
the task management module further including a task monitor configured to monitor, receive and process the user responses by detecting the timing, content or lack of user responses and update the stored data based on the processed responses; and
wherein, at each subsequent time interval, the task management module processes the updated stored data to generate an updated set of prioritized tasks for display to the assigned user by adding or reprioritizing uncompleted tasks and removing completed tasks.

In one embodiment, the task management module is configured to generate the set of prioritized tasks based on one or more of: response time; completion time; tasks completed by an assigned user in a designated time interval; tasks having one or more of the same task type or priority or in the same set;

updated appointment, patient or provider data; and user response from a set of pre-determined user responses.

In one embodiment, each task has one or more of an assigned response time, completion time, reminder time, and re assignment time.

In one embodiment, the task management module is configured to reassign the task to one or more other users if no response is received from the initially assigned user within a predetermined response time assigned to the task, or if the task remains uncompleted after a predetermined completion time assigned to the task.

In one embodiment, the task comprises one or more of confirming an office appointment, providing patient check-in information, providing provider profile information, providing available office appointment information, and confirming patient or provider insurance information.

In one embodiment, the task management module is configured to update the set of prioritized tasks at longer or shorter time intervals based on one or more of: user response time, lack of user response, task completion time, or lack of task completion.

In one embodiment, the task management module is configured to generate an updated set of prioritized tasks for an associated provider based on collective user responses for that provider.

In one embodiment, the task management module is configured to generate an updated set of prioritized tasks based on collective responses for multiple providers of a provider group.

In one embodiment, the interface module is configured to generate a display for a web or mobile user interface.

In one embodiment, the display comprises a task feed or stream displaying the set of prioritized tasks to be completed in order of task priority.

In one embodiment, the assigned users are one or more of: a provider, a provider group, a provider staff member, and an internal system user.

In one embodiment, the task management module is configured to assign one or more tasks to a software program that automatically generates an electronic message in the form of an email, text message or alert notification to the associated provider.

In one embodiment, the task management module is configured, at each time interval, to dynamically generate the set of prioritized tasks by weighing multiple prioritization factors.

In one embodiment, the task management module is configured progressively, over time, to assign uncompleted tasks to more or different assigned users.

In one embodiment, the rules engine includes rules for automatic creation of tasks when predetermined conditions monitored by the system are met, and automatic closure of completed tasks when predetermined conditions monitored by the system are met.

In one embodiment, the task management module is configured to generate and display a standard set of user responses for selection by the user.

In one embodiment, the task management module is configured to monitor and process the selected user responses across multiple task types for one or more of: determining which task types are more or less likely to be successfully completed; future assignment of task priority; or modifying the time interval for updates.

In one embodiment, the task management module is configured to collectively assign multiple uncompleted tasks to an internal system user.

In one embodiment, the task management module is configured to collectively assign multiple uncompleted tasks to an internal system user for completion during a telephone communication with an associated provider or provider group.

In one embodiment, the task management module is configured to assign a task to both a provider user and an internal system user, and to synchronize completion of the task between the assigned users.

In one embodiment, the system is configured to assign a designated number of tasks of a designated task type to a particular assigned user to monitor the user's efficiency in task completion, and apply the user efficiency in future assignments.

In accordance with one embodiment of the invention, a non-transitory computer-readable medium is provided containing instructions to control a processor to perform steps of:

processing, via a rules engine, appointment data relating to patient office visits with healthcare providers at provider facilities, wherein the processing generates tasks associated with such visits;

assigning a priority to each task based on a desired patient experience or provider efficiency;

generating, at regular or varying time intervals, a set of prioritized tasks for an associated provider and assigning the set to an assigned user for completion;

generating a display of the set of prioritized tasks, via an interactive user interface, to

enable the assigned user to access and manage the prioritized tasks, and to accept user responses for completing the tasks;

monitoring, receiving and processing the user responses by detecting the timing, content or lack of user responses; and

modifying the set of prioritized tasks based on the processed user responses and generating a display on the user interface of the modified set of prioritized tasks.

In accordance with one embodiment of the invention, a computer-implemented method is provided comprising:

selecting, via a processor, task data identifying tasks to be performed by a healthcare provider;

applying process logic and rules data for prioritizing the selected task data and generating a prioritized list of tasks;

prior to communicating the prioritized list of tasks, inputting one or more of stored patient data and provider data to the task data for partial completion of the identified tasks;

communicating the prioritized list of tasks to the provider via an interactive electronic display that allows the provider to view the prioritized list and input responses for completing the tasks;

monitoring the responses to determine completion of a listed task; and

deleting a task from the prioritized list that is determined completed;

wherein the selecting and applying steps are performed on a periodic basis for updating the prioritized task list and for communicating the updated prioritized task list to the provider in a continuous manner.

In one embodiment, the monitoring comprises detecting the timing, content or lack of responses and modifying the displayed list of prioritized tasks based on the responses.

In one embodiment, the interactive display is communicated to a first user interface; and if no response to a listed task is received from the first user interface within a predetermined elapsed time, communicating the listed task to a different user interface.

In accordance with one embodiment of the invention, a healthcare provider task management system is provided comprising:

a task module configured to receive healthcare data and to process the data by transforming the data into a prioritized list of tasks for a healthcare provider that require responses to complete;
a storage unit configured to store the task data for each task of the prioritized list; an interface module configured to generate an interactive electronic user interface for displaying the prioritized list of tasks to enable the provider to access and manage the tasks and accepting provider responses for completing the tasks;
a task monitor configured to monitor the responses; and
the task module processing the healthcare data and responses on a periodic basis to generate an updated prioritized list of tasks for display on the user interface.

In one embodiment, the system is configured to monitor, receive and process the provider responses by detecting the timing, content or lack of responses and to modify the display of the prioritized list based on the processed responses.

In one embodiment, the task module further comprises an escalation manager for delivering, after an elapsed time from an initial display of a task that lacks a response, an escalation electronic message to a different user interface.

In one embodiment, the user interface is configured to enable the provider to input, edit or reply to the tasks and the tasks comprise one or more of:

confirming office appointment scheduling data, providing patient check-in data, providing physician profile data, providing available office appointment data, and providing healthcare insurance data.

In one embodiment, the user interface is configured to display alert notifications or reminders of the tasks, and wherein the alert notifications or reminders increase in frequency with decreases in response time remaining or lack of response.

In one embodiment, the task module is configured to order the tasks within the list based on a relative priority of time-sensitivity of completion of each task.

In one embodiment, the user interface is configured to display each task in the list in order of elapsed time from the initial display of the task.

### BRIEF DESCRIPTION OF THE DRAWINGS

FIG. 1 is a schematic illustration of a task management system in accordance with one embodiment of the invention for generating and processing task data associated with a plurality of healthcare providers;

FIG. 1A is a schematic illustration of one embodiment for assigning related tasks of a workflow to users associated with providers in different provider groups;

FIG. 1B is a flow chart illustrating one embodiment of a workflow;

FIG. 2 is a schematic diagram of one embodiment of a task management module implemented as a rules engine that generates and dispatches on a continuous basis a set of prioritized tasks to be performed by an assigned user (e.g., healthcare provider support staff member);

FIG. 3 is a schematic illustration of a task template, including multiple task parameters, for use in accordance with one embodiment of the invention for processing and storing task data of different task types;

FIG. 4 is a schematic diagram of a communications system enabling an aggregator to communicate over a network with each of a plurality of patients, healthcare providers and insurance providers, in accordance with one embodiment of the invention;

FIGS. 5A-5C illustrate one example of a user interface and method of communicating a set of prioritized tasks to a user on a continuous basis, wherein the three figures provide a sequential display of the same interface as it changes over time based on user responses and processing of updated patient, provider, appointment and task data;

FIG. 6 is a schematic diagram of a user interface for managing task data in accordance with one embodiment of the invention;

FIG. 7 is a schematic diagram of another user interface for managing task data;

FIG. 8 is a flow chart illustrating one method embodiment for managing tasks performed by a healthcare provider;

FIG. 9 is a flow chart illustrating another method embodiment of the invention;

FIG. 10 is a flow chart illustrating another method embodiment of the invention; and

FIG. 11 is a flow chart illustrating another method embodiment of the invention.

### DETAILED DESCRIPTION

Various embodiments of the present invention are now described with reference to the drawings. In the following description, for purposes of explanation, numerous specific details are set forth in order to provide a thorough understanding of one or more implementations of the present invention. It will be evident, however, that the present invention may be practiced without these specific details. In other instances, well-known structures and devices are shown in block diagram form in order to facilitate describing the present invention.

As used in this application, the terms “component”, “system” or “module” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The present invention may also be illustrated as a flow chart of a process of the invention. While, for the purposes of simplicity of explanation, the one or more methodologies shown in the form of a flow chart are described as a series of acts, it is to be understood and appreciated that the present invention is not limited by the order of acts, as some acts may, in accordance with the present invention, occur in a different order and/or concurrent with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

Still another aspect of the present invention is providing a non-transitory computer-readable media having computer executable instructions for managing data associated with a plurality of tasks in the manner described herein. Such media may be based on any appropriate technologies including, but not limited to, electronic, magnetic, optical, semi-conductor, or other technologies, that maybe embodied in a hard disk, compact disk, DVD, flash memory and the like.

As used herein, the term “healthcare provider” or “provider” includes a physician, doctor or other medical professional (e.g., nurse, physician assistant) administering patient care, as well as members of his/her staff, or other entities that assist in providing such care or are responsible for maintaining the provider's scheduling calendar, patient records, billing, insurance, prescription, laboratory and other services.

A “practice group” or “provider group” may be any entity linking a group of providers through shared facilities, services or referral agreements. This may include, but should not be limited to, one or more hospitals, clinics, pharmacies, insurance networks, medical groups and multi-doctor practices.

As used herein “user” of the system means a provider, a provider group, a provider staff member or an internal system user.

In one or more embodiments of the invention described herein, the system is implemented by a centralized service provider that provides a wired or wireless network-based service to one or more providers, provider groups, and/or patients (existing or prospective). For example, the system may provide (in addition to task management) an application or web-based data processing service for online appointment booking and patient communications, including an interface to a computer, server, or other wired or wireless mobile communications device (e.g., cell phone, tablet computer, etc.) of one or more patients, providers, and provider groups.

### Task Management System

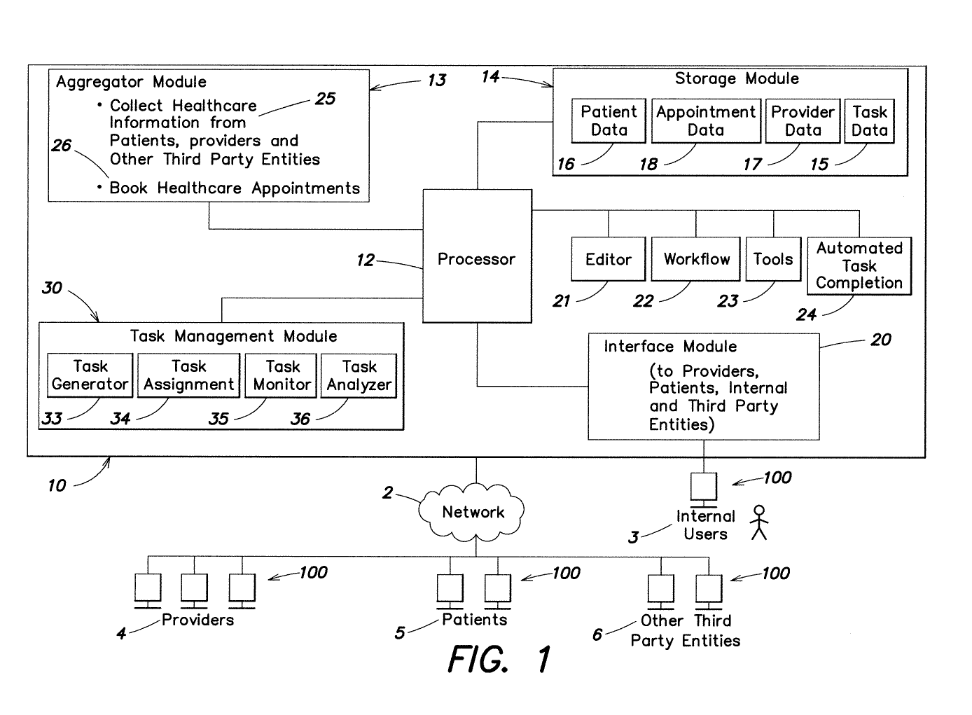

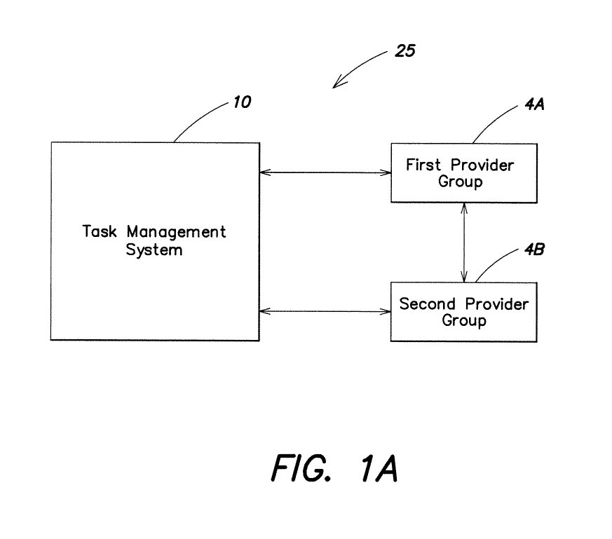

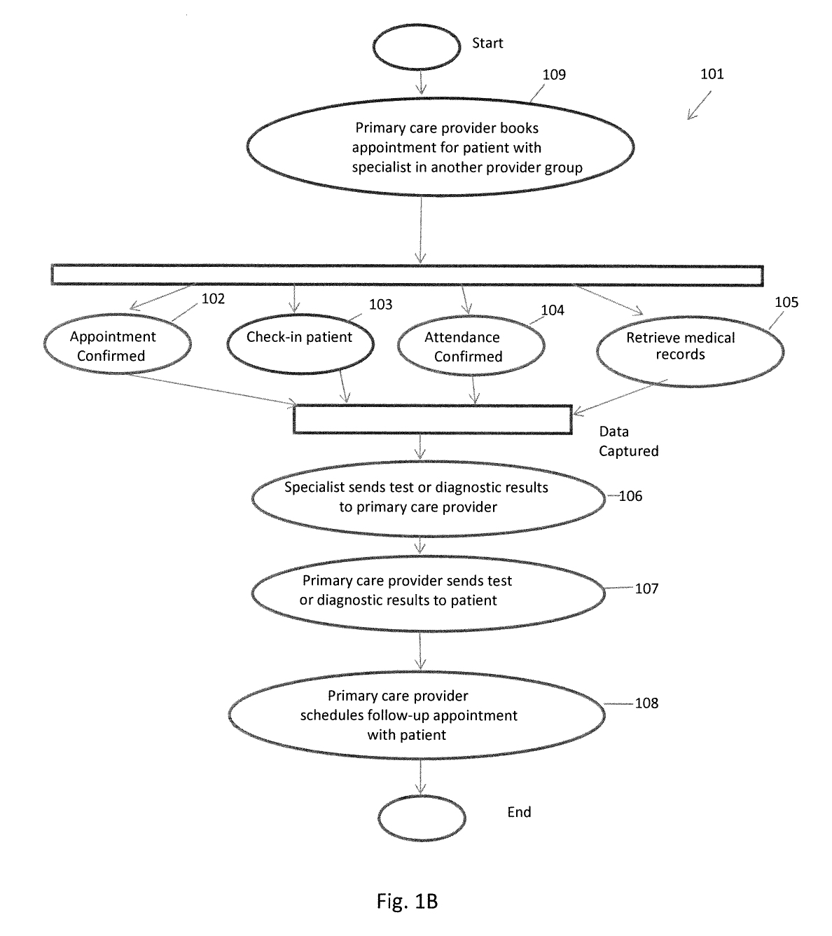

FIG. 1 is a schematic illustration of a task management system 10 in accordance with one embodiment of the present invention for managing task data associated with a plurality of providers. The system of the present invention provides features that facilitate completion of various tasks in a designated time, such as confirming scheduled office visits with patients, collecting medical information, completing patient check-in, and updating provider profile information. The system may be implemented and used for other functions and the above noted functions are merely provided as examples.

The system is provided with a processor 12 that is adapted to control and/or facilitate the functions of various modules and components of the system as described in detail below. As initially noted, the system may be implemented with any type of hardware and software, in a single location or multiple locations that are connected together using appropriate communication media and protocols. The modules are schematically illustrated based on their function for clarity purposes only, and do not necessarily represent specific hardware or software. The modules may be combined together in the system, split into submodules, or added to other modules, as desired. Thus, the invention as schematically embodied in FIG. 1 should not be construed to limit the system of the present invention.

In the illustrated embodiment, the system 10 is connected to a network 2 that allows remote access to the system so that healthcare information and data can be processed and transmitted to or from the system. The network 2 allows the system 10 or the external users thereof, such as providers 4, patients 5 and other third party entities 6, to access various sources of information in the system via terminals 100. The network may be any type of communication channel, such as the Internet, local area network (LAN), wide area network (WAN), direct computer connections and the like.

The system includes a storage module 14 in electronic communication with the processor for storing data associated with a plurality of tasks 15, patients 16, providers 17 and appointments 18. The data 15-18 may be stored in one or more databases implemented in any appropriate manner using programmable tools and development tools, and may be implemented, for example, based on an enterprise database platform such as Microsoft SQL server, Oracle, Sybase, or MySQL.

The system includes an aggregator module 13 that generates and collects (aggregates) 25 healthcare related information from patients, providers and other third party entities, all of which is stored in storage module 14. The system may also book 26 healthcare appointments for patients 5 with the healthcare providers 4, which appointment data is also stored. Some or all of this stored data may be used to generate tasks.

In one embodiment, the task data is processed utilizing a plurality of task templates, each template having a plurality of attribute fields in which attributes of the particular task can be entered and stored. When the attribute fields of a particular task template are populated with task data, which may include patient, appointment and provider data, a task template is “instantiated”, e.g., the instantiated template is associated with a particular scheduled office visit between a particular patient and provider.

An editor module 21 is provided to allow creation and editing (by internal user 3) of the task templates, for example, when a new task type is to be added to the database or if a new attribute field is to be added to an existing template.

The system also includes a workflow design module 22 which is in electronic communication with the processor 12. This module allows creation of an activity workflow for processing task data that is managed by and stored in the system. In this regard, a workflow design module can be accessed by an internal user 3 via a graphical user interface (part of interface module 20) providing a plurality of user-selectable graphical objects for creating a workflow diagram. The graphical objects may include start, end, activity, conditional flow and decision. Additional or alternative graphical objects may be provided. In various embodiments, workflows can be created via module 22 by an internal (system 10) user or by external users, e.g., providers 4 or other third party entities 6. Such workflows may assign related tasks (as part of the same workflow) to users associated with multiple providers in the same or different provider groups.

For example, FIG. 1A illustrates one embodiment for assignment of workflows across different provider groups. System 25 includes task management system 10 communicating via a network with each of a first provider group 4A and a second provider group 4B, and the first and second provider groups 4A, 4B also in network communication with each other, to enable the assignment and completion of a set of related tasks of a workflow across the two provider groups 4A, 4B. The task management system 10 stores patient data 16, appointment data 18, provider data 17, and task data 15 for both of the first and second provider groups 4A, 4B, and the task management module 30 generates assigned tasks of a workflow as determined by workflow design module 22, wherein different tasks of the workflow are assigned to one or the other of the provider groups. In the course of completing such tasks, the first and second provider groups may communicate with one or more of the task management system 10 and the other group, data relating to the completion of their respectively assigned tasks, or data to enable completion of an assigned task by the other group. Task management system 10 monitors the cumulative responses of the assigned users from the different groups to determine completion of the related tasks of the workflow. The system 10 then deletes from the prioritized set of tasks those tasks that are determined completed, and dynamically reprioritizes the task set for each of the assigned users based on the monitored responses and deleted tasks and communicates the reprioritized (updated) task sets to the respective assigned users of the associated providers.

In one example, illustrated in the tasks of workflow diagram 101 of FIG. 1B, a primary care provider (Provider Group A) initializes a workflow by booking (109) an appointment for a patient with a specialist provider in another group (Provider Group B), e.g., utilizing aggregator module 13, with patient, appointment and provider data stored in storage module 14. A workflow across provider groups (A and B) is established (via module 22 and task data stored in module 15) wherein one or both of the primary care provider and specialist is/are assigned a task of confirming the patient/specialist appointment (102) via task management module 30; the specialist is assigned tasks of checking in the patient (103), confirming the patient attends the appointment (104) and retrieving the patient's medical records (105); the specialist is assigned the task of delivering test or diagnostic results to the primary care provider (106); the primary care provider is assigned the tasks of notifying the patient of the test or diagnostic results (107) and scheduling a follow-up appointment with the primary care provider (108). The respective assigned users of the primary care and specialist providers will receive their respective tasks for completion, in a prioritized set along with other tasks for other workflows and tasks they are assigned. The resolution of tasks between the primary care and specialist groups is synchronized in accordance with the user responses, task completion and any reassignment of tasks as necessary to insure completion in a timely manner.

The workflow design module 22 also includes a plurality of predefined workflows that can be utilized or modified to create a desired workflow diagram. The provision of predefined workflows facilitates rapid preparation of workflow diagrams for common workflows without requiring preparation of such diagrams from scratch. It should be noted the activities and decision makings may be performed sequentially, in parallel, or even out of order, depending on the workflow desired. In addition, one activity in a particular workflow may itself constitute another workflow (nested workflows). Once a workflow is created, it can be saved and reused alone or in combination with other workflow diagrams, thus allowing rapid and expedited creation of workflow diagrams.

The task management module 30 includes a task generator 33 that analyzes an activity workflow diagram to facilitate generation of a plurality of tasks for processing patient, appointment, provider or other data in accordance with the created workflow. Such tasks may include, but are not limited to, confirming a scheduled appointment, printing patient check-in forms (or information), confirming patient insurance information, updating patient medical history, updating of physician profile data, etc. Each task has a priority and assigned user, as described further below.

Once the workflow has been analyzed to generate the plurality of discrete tasks, each task is assigned a defined task type name that identifies the type of processing required to complete the generated task.

The tasks are assigned and dispatched (by task assignment module 34) to a human resource (user), such as one or more support staff members of a provider or provider group 4, or staff members associated with providers of different provider groups. An assigned task may be “reassigned” to one or more other users if an initially assigned user fails to complete an assigned task in a designated time. A task may be assigned to an internal system user 3, e.g., an employee of the service provider that maintains the system 10. Alternatively, the task may be assigned and dispatched to an automated software module or device 24 that can electronically perform the required task (e.g., generate and send an appointment reminder to a patient via an email server). In making such assignments, the assignment module 34 may determine assignments based at least in part on the qualifications of various users (e.g., individual support staff members of a given provider or of the provider group as a whole). As described further below, the system monitors (via task monitor 35) the timeliness and completion rate of each user and thus learns (via task analyzer 36) which users are more efficient in accomplishing various tasks. This learned knowledge base may be used in setting qualifications for the different users and determining rules for the initial assignment or reassignment of tasks by task assignment module 34. In other embodiments, the monitored behavior of the entire provider group is analyzed and used to determine and select one or multiple assigned users, desired response times, task presentation format, reminder time, reassignment time, etc. In other embodiments, the monitored behavior of users across multiple provider groups is analyzed and used to determine task characteristics; such monitored behavior may also be used to determine a set of related tasks that comprise a “best workflow” for future assignments to providers across multiple provider groups.

The task monitor module 35 is adapted to monitor the status of tasks assigned to each of the users. Each task can be indicated as being “new”, “allocations waiting”, which means there are some resources that need be provided before the task can be completed, “executing”, or “completed”. Such task status information is stored along with the other task data 15 in the storage module 14, and may be provided to an administrator of the system (internal user 3) and to task analyzer 36 for monitoring tasks which require completion, monitoring user behavior, and other analysis.

The task assignment 34 module can be implemented to restrict the level of access of the assigned user to the system, based on the user's qualifications, so that the user is only allowed to access data in the system that is required to complete the assigned task.

The system also includes an interface module 20 that is adapted to allow a user to interface with the system to complete the assigned task. For instance, the interface module allows the user to receive the task that is assigned by the task assignment module 34, accept or decline the task, access the required information in one or more databases (of storage module 14), complete the assigned task, and update the system 10 accordingly. These actions by the user of the interface module are provided as examples only, and are not limiting.

The system communicates with terminals 100 that are accessed by patients 5 and users (e.g., providers 4, other entities 6 and internal users 3) to complete the task assignments by interfacing with the interface module 20. The terminals may be remotely located from the interface module but in electronic communication with the interface module via a wide area network.

The interface module 20 may be implemented to include a plurality of plug-ins, or software programs and modules, which serve as building blocks for providing an appropriate interface such as a customized interface screen. For example, a plug-in may be a program that provides a web browser tool, or a group of free-form text input windows, etc. In this regard, each of the plurality of plug-ins of the interface module may be associated with a particular task or tasks, e.g., via the task type names described above, which are assigned by the task module 30. The interface module 20 identifies the assigned task (e.g., by task type name) and executes the appropriate plug-in that is associated with the assigned task. The executed plug-in customizes the user interface provided to the terminal 100 to facilitate processing and completion of the assigned task by the user.

The system is also provided with a tools module 23 that provides various tools to expedite the completion of the assigned tasks. For example, the tools may provide drop down-menus or the like on the user interface 20 from which standardized responses can be selected by the user during the performance of the assigned tasks. These standardized responses can be monitored and analyzed (via the task analyzer 36) across the system for determining preferred methods of prioritizing tasks.

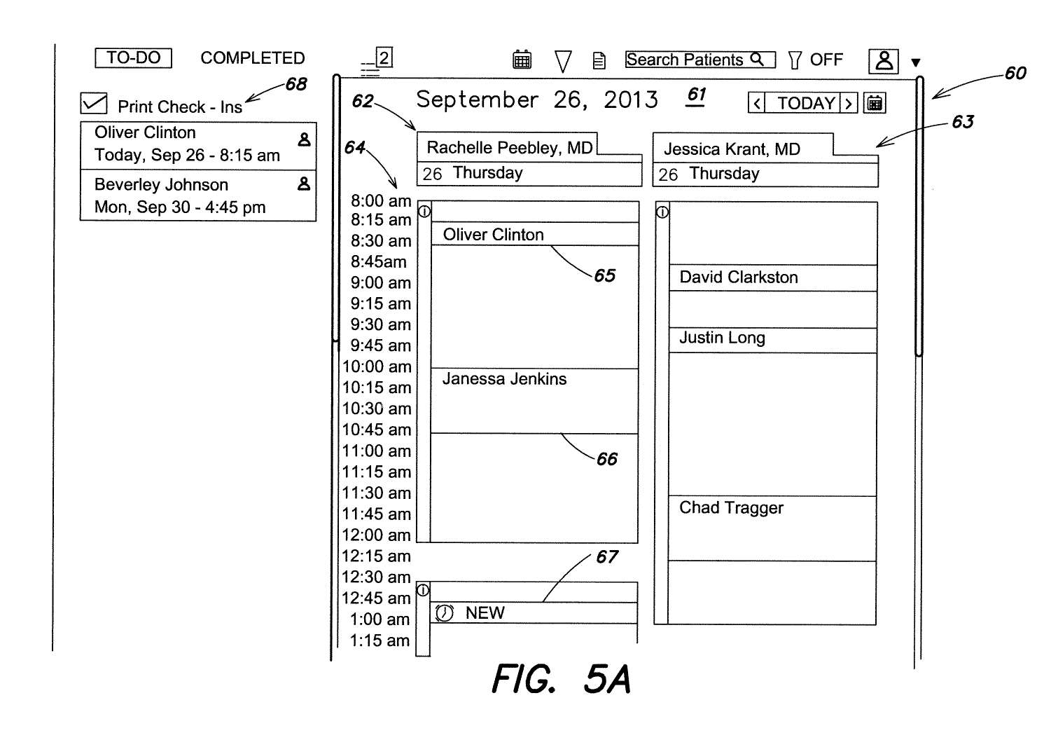

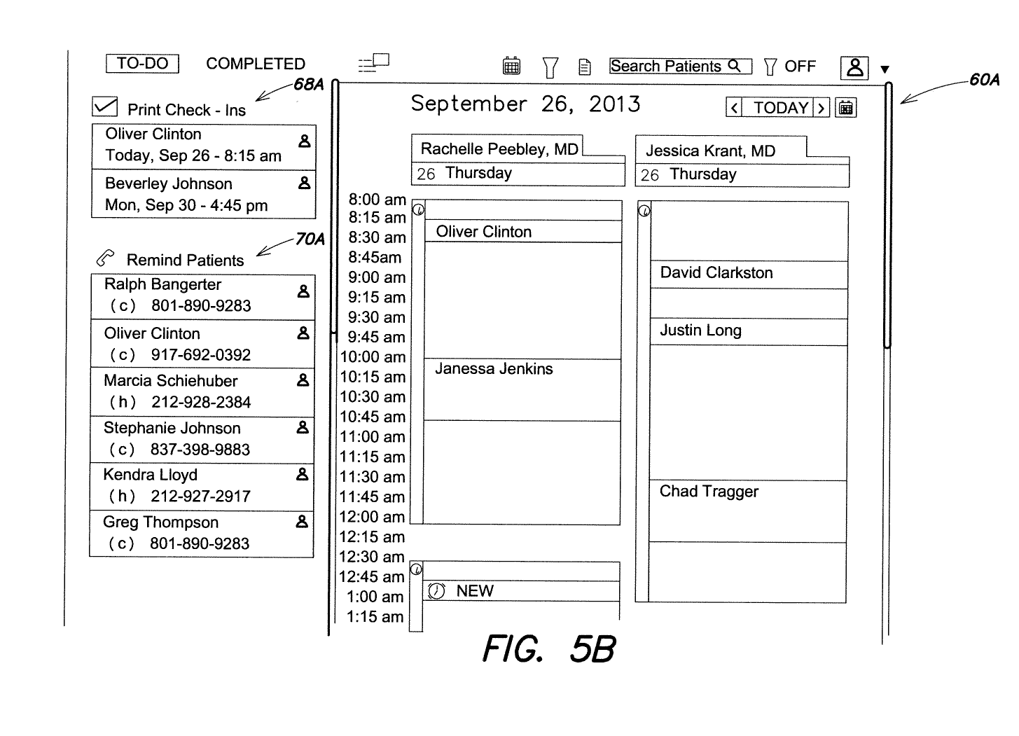

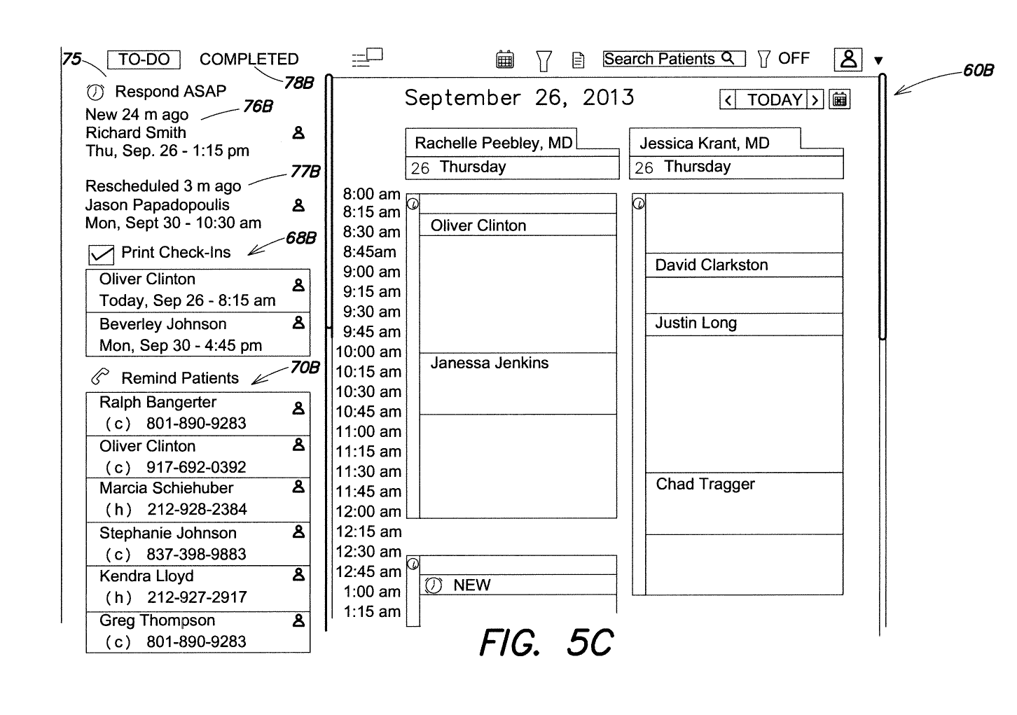

As further described below, in relation to FIGS. 5-7, the interface module 20 may be implemented to provide a graphical user interface to the respective terminal 100 so that users can perform the task of processing data that is assigned to them. In one example, when a task has been assigned to a user by the task assignment module 34, a message is provided in a new task window. The task window may include an estimated time required for the user to complete the task in an estimated time field, and also provide a small description of the task that has been assigned in a description field. The user can retrieve the assigned task by selection of a “retrieve” button, or temporarily ignore the assigned task by selection of an “ignore” button. Upon selection of the “retrieve” button, the interface provides another more detailed interface screen which allows the user to manage the selected task. As previously described, the interface screen may be customized (e.g., by execution of an appropriate plug-in) to facilitate performance of a particular type of assigned task, or customized for a particular user.

### Rules Engine and Knowledge Base

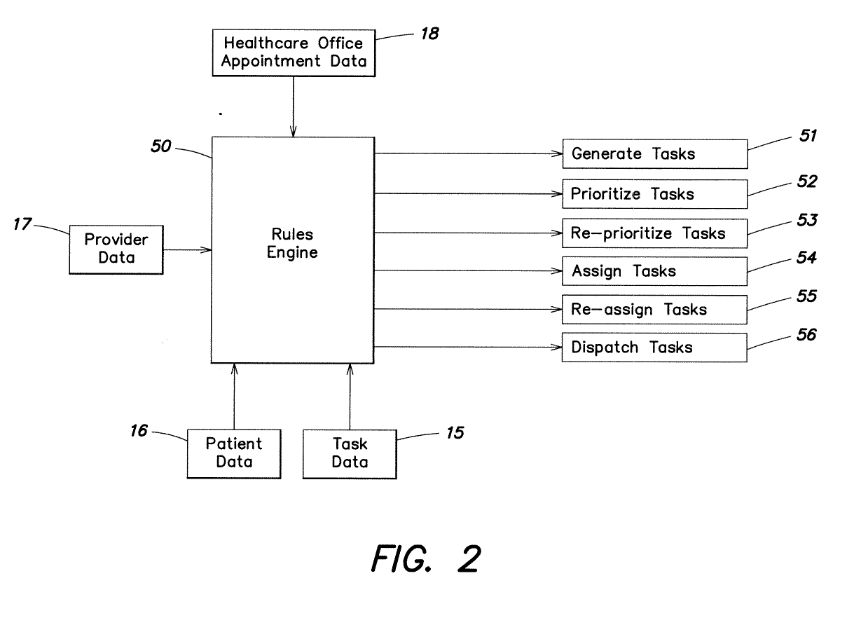

FIG. 2 illustrates one embodiment of a task management module implemented as a rules engine 50 of process logic and rules data that generates and dispatches on a continuous basis (at regular or variable time intervals) a prioritized set of tasks to be performed by a user (e.g., healthcare provider). The rules engine 50 receives, for example, patient information from patient database 16, which may include, for each patient, medical history, demographics, family history, patient contact information, and insurance information. The rules engine also receives, for example, provider information from provider database 17, which may include, for each provider, available or scheduled appointment information, accepted insurance information, office locations, specialties, and other physician profile information. The rules engine may also receive scheduling information from an appointment database 18. The rules engine also receives task data from a task database 15, e.g., identifying actions that need to be processed by a healthcare provider (generally by the support staff of the provider) within a designated time period. The rules applied by the rules engine determine a set of prioritized tasks for an assigned user based on relative priorities, task types completion times or other attributes. The rules may be based on system determined best practices or may be customized by provider.

As described in more detail below, rules engine 50 implements the rules logic and data stored in the databases 15-18 for generating prioritized task lists on a continuous basis (regular or variable time intervals) for each associated provider. The rules engine contains application logic that identifies and determines a prioritized task list for a specific provider and monitors completion according to different rules and communications that can be customized by/for different providers or different users assigned tasks for an associated provider. The time for response and/or completion rates of the various users or providers may be monitored and optionally compared over time to determine which communications (e.g., content, format, delivery method, timing and frequency of delivery) are more effective in producing task completion. Such monitoring or tracking may be accomplished by the monitor (tracking) module 35 illustrated in FIG. 1. One example of a desired action (task) is to obtain from a provider confirmation of an office appointment scheduling request (accept or deny an appointment time), which scheduling may be accomplished by the aggregator booking module 13 of FIG. 1. In one embodiment, the system 10 may process current data stored in module 14 at set time intervals, e.g., every 10 minutes, to generate new prioritized tasks for all users based on changes to the stored data over the prior 10 minutes. Alternatively, the updating may occur at different times and rates for different types of tasks or users.

As previously described, the rules engine 50 may perform such functions as: generating tasks 51; prioritizing tasks 52; re-prioritizing tasks 53; assigning tasks 54; reassigning tasks 55; and dispatching tasks 56. These functions are representative and not limiting.

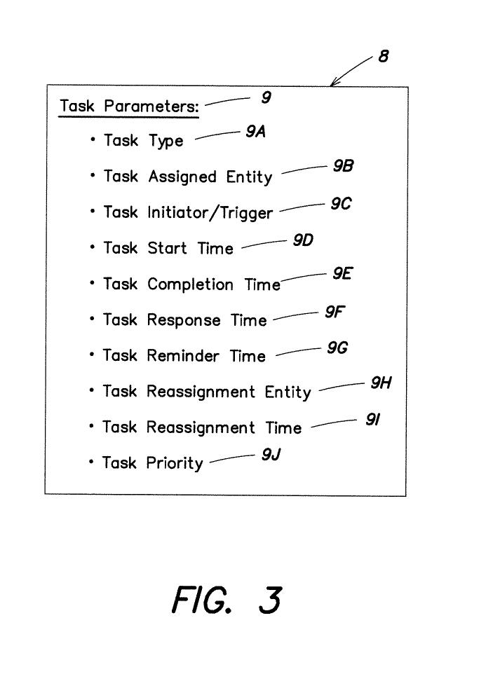

FIG. 3 illustrates one example of a task template 8 including multiple task parameters or attributes 9, which are generally self-descriptive. In this example, the task attributes include: task type 9A, task assigned entity (provider) 9B; task initiator/trigger 9C; task start time 9D; task completion time 9E; task response time 9F; task reminder time 9G; task reassignment entity 9H; task reassignment time 91; and task priority 9J. The use of these attributes has been previously described and is further illustrated in the method embodiments set forth below.

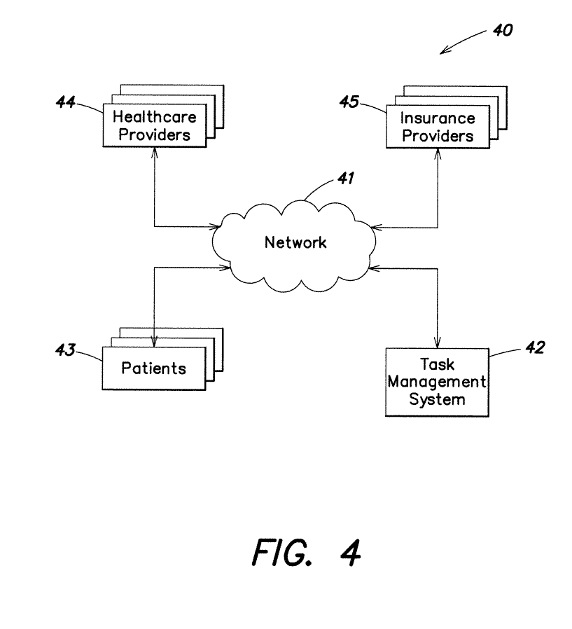

FIG. 4 illustrates a communications system enabling the task management system 42 to communicate over a network 41 with each of a plurality of patients 43, healthcare providers 44, and insurance providers 45, according to the present invention. For example, the system may both collect patient data from one or more of the patients 43, healthcare providers 44, and insurance providers 45, for populating the patient, provider and appointment databases 16-18. In addition, the system may communicate with patients 43, healthcare providers 44, and insurance providers 45, to track the provider (and optionally patient) responses to determine completion of a designated task. Still further, the system 42 may communicate with patients 43, healthcare providers 44, and insurance providers 45, in order to enable providers and patients to take the desired actions, such as scheduling a healthcare appointment, completing a patient request for a refill prescription, or providing updated information for a physician profile maintained by the system 42, healthcare provider 44 and/or insurance provider 45. Still further, the system 42 may receive from the healthcare providers 44 and insurance providers 45 data for formulating custom rules and recommendations for the respective patient populations of the providers, which custom rules and recommendations would then take precedence over (override) the more general rules and recommendations of the system 42.

Prioritized Task User Interface

FIGS. 5A-5C illustrate one example of an interface and method of communicating a prioritized set of tasks to a provider on a continuous basis. Here, the communications are via one or more webpages on a website accessible to an assigned user, here a staff member of the provider. The webpages provide an interactive graphical user interface (e.g., dashboard) for the staff member to monitor and complete tasks. In a central window 61 of the first webpage 60 (FIG. 5A) there is provided a current appointment schedule for the day (e.g., Sep. 26, 2013), with appointment notices for the associated providers listed in separate columns 62, 63 below each provider's name, and aligned with a column 64 of associated appointment times throughout the day. The first provider 62, Rachelle Peebley, has two scheduled appointments in the morning, one appointment entry 65 from 8:15 to 8:30 a.m. with patient Oliver Clinton, and a second appointment entry 66 with patient Janessa Jenkins from 10:00 to 10:45 a.m. In the afternoon at 12:45 to 1:00 p.m., there is an entry 67 (for Rachelle) with the icon of a ringing alarm clock and the text “New”, describing a particular task for completion by the assigned staff member, namely acceptance or denial of a proposed new appointment at the designated time. The staff member can complete the action by clicking on the icon 67, which links to another page or pop-up window providing details of the appointment and links for either acceptance or denial of the appointment. The staff member can thereby immediately complete the task, by clicking on the interactive display. This action (provider response) automatically updates the relevant databases (e.g., databases 15-18 in FIG. 1), which in turn modifies the display 60 to indicate a completed task.

The webpage 60 (of FIG. 5A) has another window 68 on the left hand side containing a prioritized list of “Print Check-Ins,” a second (different) type of task to be completed by the staff member. These tasks are designated in the order of the scheduled appointments of the day, e.g., the 8:15 a.m. check-in is listed before the 4:45 p.m. check-in. Again, the staff member can complete the task by clicking on the designated link for the respective appointment check-in, to complete the task. Upon completion of the task the display 60 is modified to acknowledge completion. Note that not all patient appointments have a print check-in, namely the 10:00 a.m. appointment for Janessa Jenkins is not included in the prioritized list of check-ins. Again, this simplifies the burden on the staff member by listing in one location of the display screen only those appointments requiring a specific task type, print check-ins, and in order of desired completion time.

FIG. 5B shows the same dashboard 60 at a later time on the same date, now referenced as 60A. There now appears below the “Print Check-Ins” 68A a prioritized list for a third task type named “Remind Patients” 70A, shown with a telephone icon. This list includes the names and telephone numbers of patients for a plurality of providers being handled by the support member in relative order of priority (within this task type) based on desired completion time, here determined by the relative appointment times (with the nearest in time appointment listed first and the farthest in time appointment listed last). Again, the staff member can complete each task by clicking on the respective link, which automatically dials the designated patient's telephone number to initiate a call or deliver a machine generated appointment reminder. The display 70A is then modified to acknowledge completion of the task. Alternatively, if the support member manually calls the number, the display (after an elapsed time) may prompt the member to confirm (via the display) that this patient has been called (task completed).

FIG. 5C illustrates the same interface 60 at a still later time on the same date (Sep. 26, 2013), now referenced as 60B. The display now includes a prioritized list 75B entitled “Respond ASAP”, with an alarm clock icon. In this case, the prioritized list 75B is provided first, at the top of the left hand column, above the “Print Check-Ins” 68B and “Remind Patients” 70 lists. Thus, in addition to each individual task type list being prioritized on the display 60B, the relative priority of the respective lists is also apparent, e.g., by order on the page 60B. In this example, there are two entries under the first priority list, a new appointment for patient Richard Smith to be accepted or denied 76B, and a rescheduled appointment for patient Jason Papadopoulis to be rescheduled at the designated time 77B. The support member simply clicks on the respective link to complete the task (i.e., accepting or denying the new or rescheduled appointment) whereby the appointment and task databases 18 and 15 (FIG. 1) are automatically updated with the appointment information and task completion. The display 60B is automatically updated following completion of the respective task. Optionally, the staff member can click on the “Completed” button 78 to view a list of completed tasks.

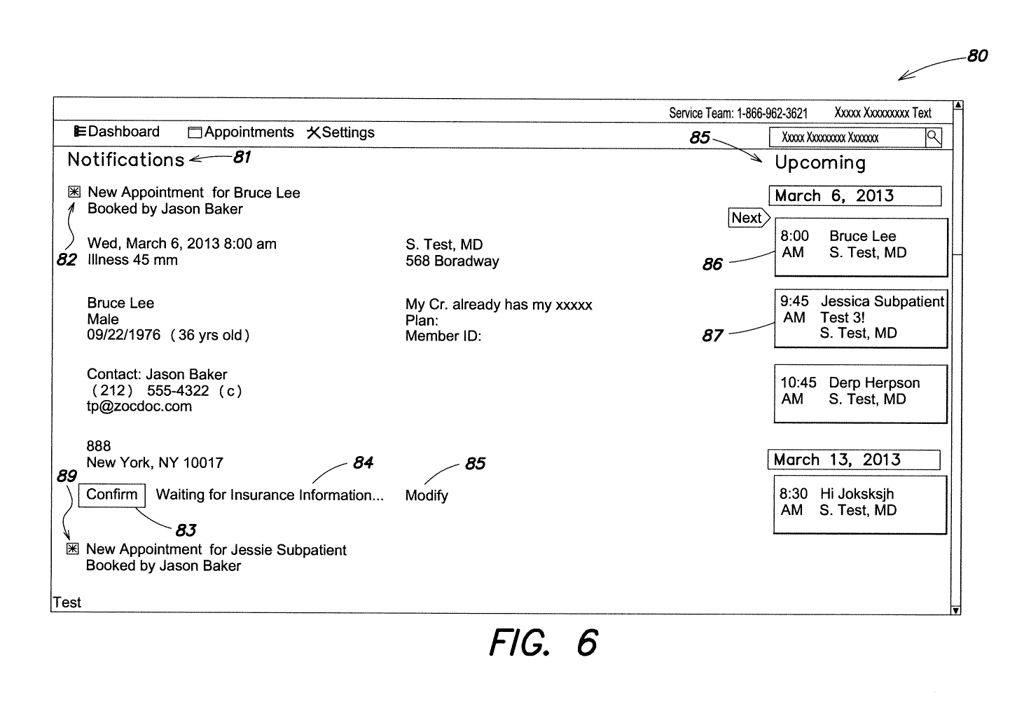

FIG. 6 illustrates another user interface 80 for managing task data. Here, the interface has an enlarged left hand window 81 labeled “Notifications” containing a prioritized list of new appointments. The first entry 82 is a new appointment for Bruce Lee with a physician S. Test M.D. on Mar. 6, 2013 at 8:00 a.m. This display entry 82 includes details concerning the patient's age, gender, insurance plan and member ID, reason for the visit, appointment time, and physician office location. This appointment was booked by the patient on an aggregator website (ZocDoc.com) providing online appointment services for multiple practice groups. The staff member can complete the task by clicking the “Confirm” button 83. Alternatively, the staff member can click another link 84 entitled “Waiting for insurance information” to indicate that the appointment will not be confirmed until the insurance information is provided. A third link 85 entitled “Modify” enables the support member to enter the necessary insurance information as part of the task data.

The right hand window 85 labeled “Upcoming” (on the same interface 80) contains a summary list of upcoming appointments on each designated date, again in prioritized order of earlier to latest appointments each day. Once the staff member completes the first notification task 86 on the top of the list 85, namely the 8:00 a.m. appointment for Bruce Lee, the “Next” flag 87 will move down to the second item 87 on the prioritized list, namely the 9:45 a.m. appointment for Jessica Subpatient. At the same time the notification 89 for the Jessica Subpatient appointment will be moved to the top of the left hand window 81, automatically providing the support member with the next relevant task to be completed.

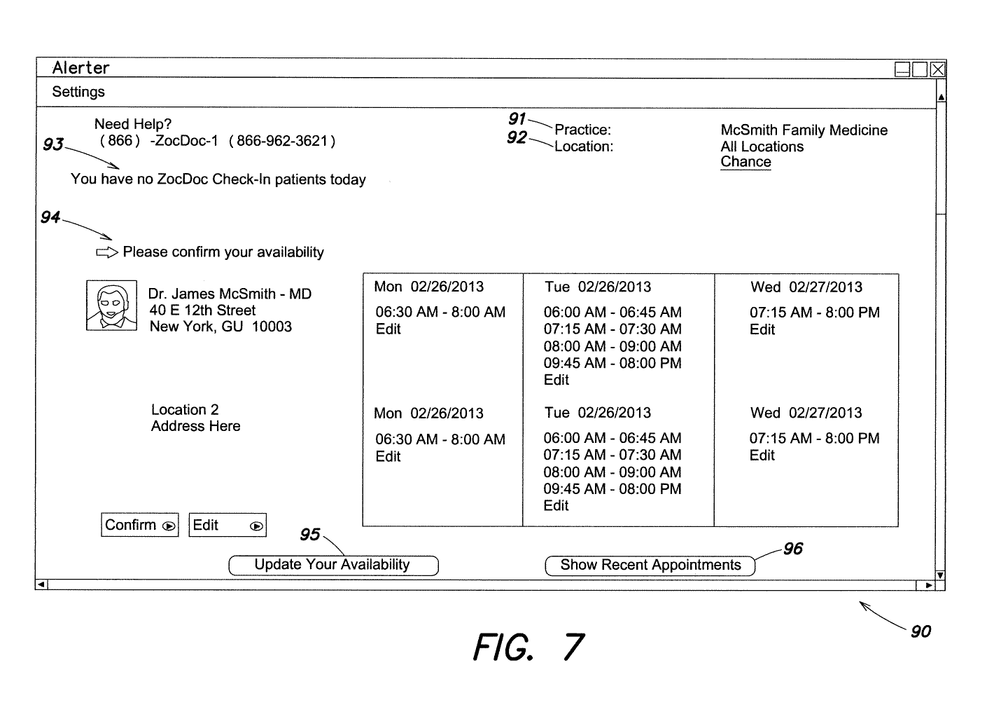

FIG. 7 illustrates yet another interface (webpage) 90 for a provider. In the upper right hand corner the interface identifies the provider group 91 for task management as “McSmith Family Medicine”, and the location 92 for the practice group as “All Locations”. For this provider group and location, a first window 93 indicates there are no more Check-In patients today, and there are no appointments being brought to the attention of the provider. In a second window 94 (below the first window) the provider is prompted to confirm the availability of Dr. James McSmith, one provider in the group, at a first designated location, on three upcoming dates listed across the page, and at a second location on the same three dates. The provider is prompted to confirm the designated availability of appointment time slots at the respective dates and locations or to edit the respective time slots. The provider then clicks on the “Update Your Availability” button 95 on the bottom of the page to confirm the original or edited time slots. This action updates the scheduling records (e.g., appointment database 18 of FIG. 1), allowing the system to offer these available appointment times to patients on the system's online appointment booking website or mobile application. A second button “Show Recent Appointments” 96 allows a provider to request a display of recent appointments scheduled via the system. Again, based on the user responses provided, data stored in one or more of databases 15-18 (of FIG. 1) will be updated. The next scheduled update for generating prioritized sets of tasks will thus be based on such stored updated data.

The above interface formats and methods are representative examples and not meant to be limiting.

### Task Management Methods

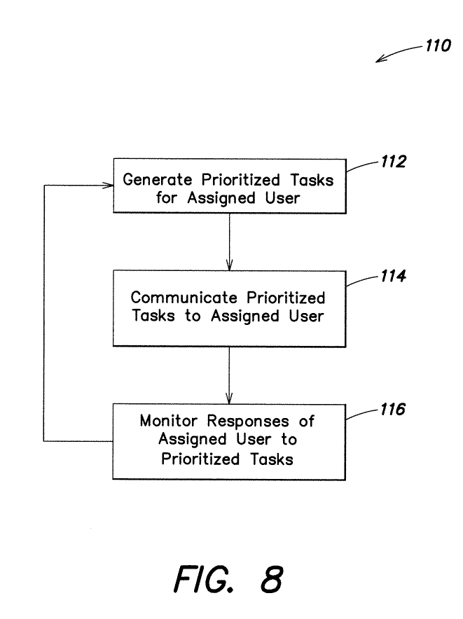

FIG. 8 illustrates one method embodiment 110 for managing tasks performed by a provider. The method includes generating 112 a prioritized set of tasks for an assigned user, communicating 114 the prioritized tasks to the assigned user, and monitoring 116 responses of the assigned user to the prioritized tasks, wherein the method returns to step 112. For example, the tasks may include accepting or denying a new or rescheduled appointment, printing of patient check-in data, and reminding a patient of an upcoming appointment. The method may be implemented by the system 10 illustrated in FIG. 1, wherein a server includes a task management module (rules engine) 30 and an interface module 20. The modules of server 10 communicate with various databases such as a patient database 16, provider database 17, appointment scheduling database 18 and task database 15, as described above.

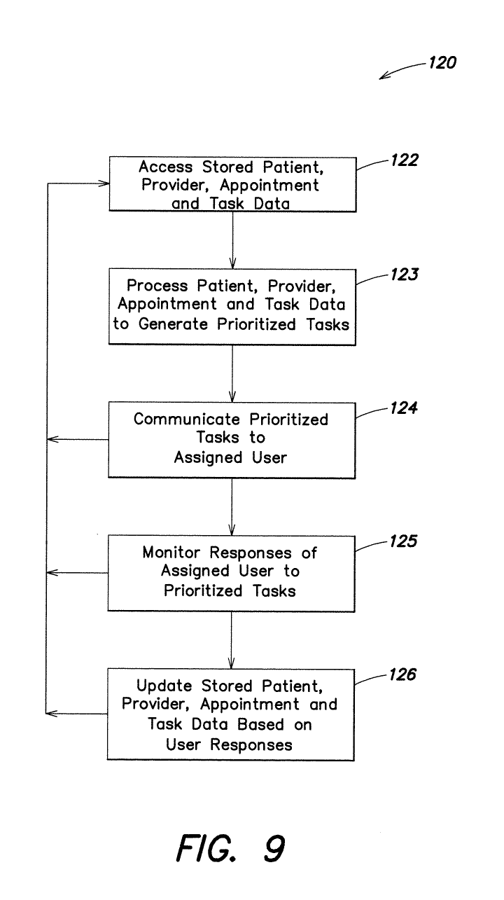

FIG. 9 illustrates yet another method embodiment 120 of the invention. Here a task module accesses stored patient, provider, appointment, and task data in step 122 in order to partially complete (simplify) one or more tasks while generating the set of prioritized tasks 123. For example, the stored data is used to complete one or more steps of a task, such as filing in the patient's insurance information, before sending the associated provider a request to confirm an appointment with this patient. The provider's staff member is thus relieved of independently determining the patient's insurance information, since it is provided with the confirmation task. The set of prioritized tasks are then dispatched (electronically communicated) to an assigned user (e.g., staff member of the provider) 124. The task module monitors 125 the responses to the communicated tasks, and generates and stores updated patient, provider, appointment and task data based on the user responses 126. During such monitoring 125, the task module may continue to access updated patient, provider, appointment and task data stored in the system, in order to generate new tasks and re-prioritize the tasks, for generating an updated set of prioritized tasks that are sent to the user. This continuous generating, monitoring and updating of task completion, while utilizing updated patient, provider, appointment and task data for generating new or modified tasks, enables a healthcare provider (generally the support staff) to more efficiently process the ongoing and continuously changing tasks from a single source (interactive electronic display), relieving the provider/staff from the burden of monitoring multiple task sources and from the burden of tracking completion and determining the relative priority of tasks. The system 10 (in FIG. 1) also partially completes the task, e.g., utilizing the stored data in storage module 14. In this example, the system accesses and processes the patient, provider, appointment and task data 15-18 (FIG. 1). In other examples, it may access and process one or more of these, or other stored data (of system 10), to generate or simplify the generated tasks.

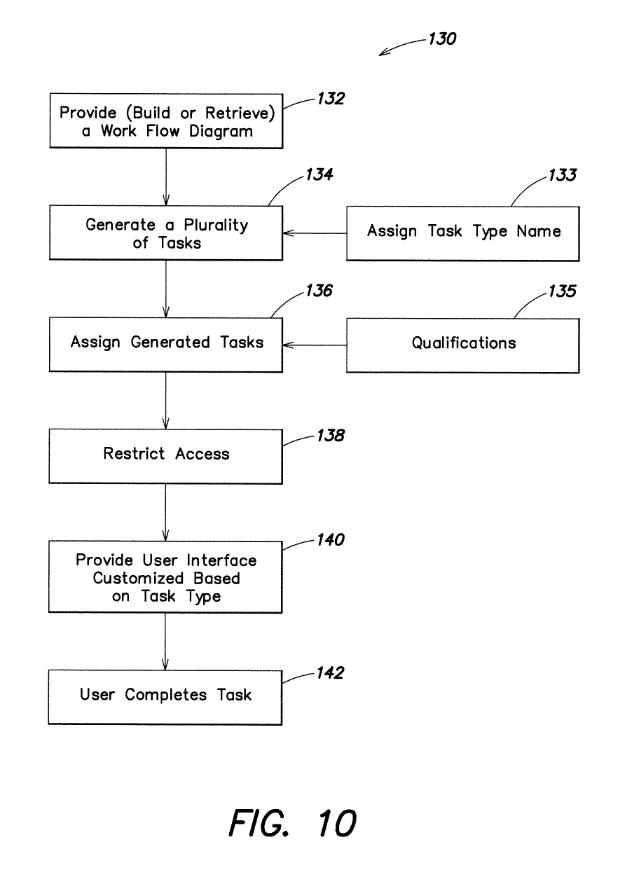

In accordance with another aspect of the invention, a method is provided for managing tasks performed by providers, which includes providing custom (different) user interfaces based on task type. In this regard, FIG. 10 is a flow diagram that schematically illustrates this method 130 in accordance with one embodiment of the present invention. In step 132, a workflow diagram is created or retrieved (from storage). In step 134, a plurality of tasks is generated for processing data according to the workflow diagram. Each task may be assigned a relevant task type name 133.

The generated tasks are each assigned to a user 136 for completion. In this regard, the assignment may be based on considering the qualifications of the users as shown in step 135, including such qualifications as skill set, resources, monitored performance (prior behavior regarding completion of assigned tasks), etc. The processing of data for the assigned task may be patient check-in, updating provider profile, or confirming an appointment. For each user, access to the information in the system may be restricted 138, so that the assigned user is only allowed access to the data needed to complete the assigned task.

In step 140 a user interface is provided to the user which has been customized (e.g., by execution of an appropriate plug-in) to facilitate processing of the task by the user. The user completes the task in step 142. The method of FIG. 10 is provided as an example of the present invention and is not limiting.

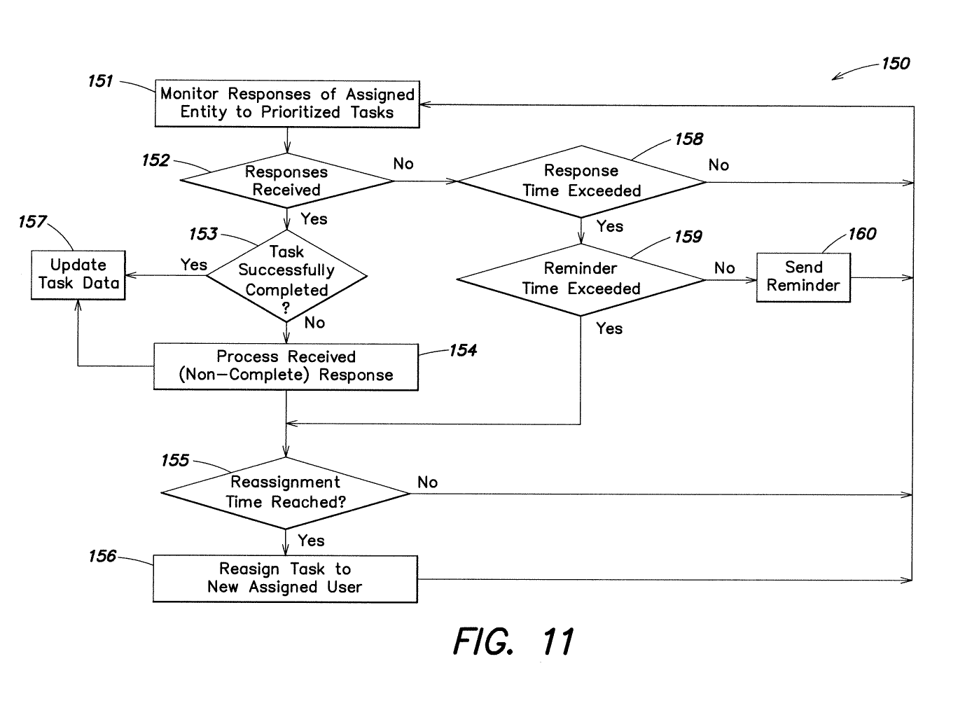

FIG. 11 illustrates yet another method embodiment 150 of the invention for monitoring responses and reassigning tasks where a response (indicating completion) is not provided in a designated time. A first step 151 comprises monitoring responses of an assigned user to its assigned prioritized tasks. In the next step 152, it is determined whether a response is received from the user. If no response is received, it is next determined whether the desired response time has been exceeded 158, If not, the process returns to the first step 151 to continue monitoring the responses.

If a response is received, it is next determined 153 if the task has been completed based on the response content. If not, the method processes 154 the response and updates 157 the task data stored in task database. If the task has been successfully completed, the task data is updated 157. After processing the non-complete response, it is determined 155 whether a reassignment time has been reached. If not, the process returns to the first step 151 to monitor responses of the assigned user. If the reassignment time has been reached without completion of the task, the process reassigns 156 the task to a new assigned user. The process then returns to monitoring the responses 151 of the newly assigned user.

### Alternative Embodiments

In one embodiment, referred to as dynamic task reprioritization, tasks of the same type are given a different priority based on multiple factors. For example, not all tasks of the same type assigned to a provider, e.g., to confirm an appointment, are equally important (urgent) to complete in the same time period. An appointment which occurs three months from now is less urgent than one that is scheduled for tomorrow. Similarly, if a first patient transmitted an appointment request prior (5 days ago) to a second patient (1 day ago), the system will give weight to the fact that the first patient has been waiting longer for a response and thus give that confirmation of appointment task a higher value than the confirmation of the appointment task of the second patient. By using multiple reprioritization factors, the system can ultimately balance multiple goals to optimize outcome for patient service.

In another embodiment, referred to as aggressive task assignment broadening, a given task may be assigned to additional or replacement users (providers) based on how long the task has been outstanding. For example, originally a task may be assigned to the smallest group of users who can complete the task (e.g., having the specialized skill appropriate to the task); however, if elapsed time begins to approach a threshold of a desired completion time (e.g., a service level agreement), then the system can assign the task to additional users, to ensure it is completed in the desired time.

In another embodiment, referred to as cross organizational workflows, the system composes workflows that extend across organizational work boundaries, namely the tasks are assigned to entities in multiple organizations. For example, a task “call patient X to confirm her appointment” can be assigned and dispatched to a provider's office via a web interface. If the provider's office does not complete the task within a dynamically adjustable time, the task can be re-dispatched to an internal entity (system user) to complete. During the time the task is assigned and visible to both entities, its resolution is synchronized; if one of them completes the task, the other will know this has occurred and will not take the same action. In another example, the task can be re-dispatched to software that completes the task automatically, e.g., by dispatching an automatic phone call or email to the patient to confirm her appointment.

In another embodiment, referred to as dynamic task assignment examination, the system can differentiate which tasks are assigned to which user based on previously observed (monitored) behavior. For example, if a first user has previously been observed to respond to a particular type of task in a lower amount of time, those tasks can be preferably dispatched to that user. Conversely, the system can be configured to guarantee that a sufficient number of a certain task type be dispatched to a new user, in order to monitor and measure that user's proficiency for future use in assigning tasks.

In another embodiment, referred to as dynamic task settings determination, the system can differentiate particular characteristics of individual tasks based on previously monitored behavior. For example, if a particular provider's office is observed to be particularly fast (quick response time) in responding to a task type, then the “timer” that determines how long to wait before reassigning the task to an internal user or another provider user can be dynamically adjusted (e.g., for medical practice A the system only designates 5 minutes before extending (assigning) the task to another user, having observed that 90% of the time, medical practice A has responded within 2 minutes, whereas for practice B, the system waits 10 minutes (longer time), having previously monitored and found that practice B has a 90% response time of 8 minutes (longer response time)).

In another embodiment, referred to as automatic task initiation, the system is programmed with rules for creating tasks automatically, when events arise requiring such tasks (a trigger or initiation event). In one example, a rule monitors when a software program installed at a provider office last communicated with the system. If the system determines that the communication has not occurred within a designated time period, a task is automatically created and dispatched to an assigned internal system user to communicate with the provider regarding the status of that software program on the provider's site. After the task is created and dispatched, at the next scheduled task generation time (e.g., every ten minutes), the system rule checks whether the provider program has communicated with the system, and if it has, the task is automatically closed by the system and is no longer included in the prioritized set of tasks for the internal user.

In another embodiment, referred to as standardized resolutions and reporting, the assigned user is provided with a standard set of response options to select from. Standardizing the response options allows for comparisons of responses across all task types, despite the task types requiring sometimes dramatically different amounts of work to complete. It allows the assignment algorithms to better assess priority across different task types and subsequently base task assignments on the likelihood of the different tasks being completed. For example, as the system shows which tasks are harder to be successfully completed for any of these standard reasons (response options), the system can assign those tasks a higher priority. In one or more embodiments, the task assigned a higher priority is dispatched to the same assigned user before a task assigned a lower priority.

In another embodiment, referred to as dispatching tasks based on user behavior, the system (rules engine) processes the stored data to determine a greater amount of work (e.g., outstanding tasks) that can be achieved by a single user, such as an internal user, and then assigns multiple tasks to the internal user. For example, it can be difficult to reach a provider by telephone; if that form of communication is part of an assigned or reassigned task, then the internal user task includes communicating with the provider by telephone (in one call) about the multiple outstanding tasks that have not yet been completed.

In another embodiment, referred to as inbound calling, an internal user is assigned multiple outstanding tasks for completion when a provider, associated with the multiple outstanding tasks, communicates with the internal user (e.g., an inbound call by the provider to the internal user), in order to complete as many outstanding tasks as possible during the inbound call session.

In another embodiment, referred to as prioritizing tasks based on empirical knowledge of their value, the system assigns priorities based on a relative value of completing each outstanding task. For example, a provider may have a photo on a website accessible to patients, and prior patient input to that website has found that multiple patients respond negatively to the question of whether they would select this provider when presented with the provider's photo. The system may generate one task of prompting the provider to change his photo on the website and give this task a high value (priority) because the value (to the provider) of completing this task is high. The provider may have another outstanding task requiring him to update his office locations. As the system has determined that the existing provider's photo is generating a high negative response rate, the system may assign the first task, changing the provider's photo, the higher priority, namely higher than the second task of updating the provider's locations.

What has been described above includes examples of the present invention. It is, of course, not possible to describe every conceivable combination of components or methodologies for purposes of describing the present invention, but one of the ordinary skill in the art will recognize that further combinations and permutations of the present invention are possible. Accordingly, the present invention is intended to embrace all such alternations, modifications and variations that fall within the present disclosure and/or claims.

1. A computer-implemented method comprising:
selecting, via a processor, stored task data identifying multiple related tasks of a workflow for completion by multiple healthcare providers from different provider groups;
applying process logic and rules data for assigning different related tasks of the workflow to different assigned users each associated with a different one of the multiple healthcare providers;
applying process logic and rules data for generating a prioritized set of assigned tasks for each respective assigned user;
communicating each prioritized task set to the respective assigned user of the associated healthcare provider via an interactive electronic display that allows the assigned user to view the prioritized set and input responses for completing each assigned task;
monitoring the cumulative responses of the assigned users to determine completion of the related tasks of the workflow;
deleting from the prioritized task sets, tasks that are determined completed; and
dynamically reprioritizing the task sets for each of the assigned users based on the monitored user responses and deleted tasks and communicating the updated reprioritized task sets to the respective assigned users of the associated healthcare providers.

2. The method of claim 1, wherein the monitoring step comprises detecting the timing, content or lack of user response.

3. The method of claim 1, including reassigning tasks to one or more other users based on timeliness of user response or determined task completion.

4. The method of claim 1, wherein the assigning step determines which tasks are assigned to which user based on previously monitored user responses.

5. The method of claim 1, wherein the stored task data includes different versions of a task and the method of assigning assigns different task versions to different users based on previously monitored responses of the respective user.

6. The method of claim 5, wherein the different versions include a different designated response time or completion time.

7. The method of claim 1, including assigning each task one of multiple task types and task priorities, and displaying the prioritized set of tasks of the respective user arranged by task type and priority.

8. The method of claim 7, including generating and displaying a standard set of user responses for selection by different users.

9. The method of claim 8, including comparing user selection of standard responses across multiple task types.

10. The method of claim 9, wherein the assigning step includes assigning a different task priority or assigning a different user based on the compared user selection of standard responses.

11. The method of claim 1, further comprising analyzing the monitored responses of different assigned users to identify differences in timeliness or completion.

12. The method of claim 11, wherein the analyzing step comprises comparing the responses of users associated with providers in the same provider group.

13. The method of claim 11, wherein the analyzing step comprises comparing the responses of users associated with providers in different provider groups.

14. The method of claim 1, further comprising, for at least one prior stored task of a workflow, modifying the prior stored task based on a monitored user response, and storing the modified task.

15. The method of claim 14, further comprising analyzing the monitored user responses by comparing user responses to the prior and modified tasks for timeliness or completion.

16. The method of claim 14, wherein the analyzing step comprises comparing responses of the same user to the prior and modified tasks for timeliness or completion and associating one of the prior and modified tasks for future assignment to the same user.

17. The method of claim 15, wherein the analyzing step comprises comparing responses of different users to the prior and modified tasks for timeliness or completion and associating one of the prior and modified tasks for future assignment to users.

18. The method of claim 15, wherein the analyzing step comprises comparing user responses to the prior and modified tasks across different provider groups.

19. The method of claim 15, wherein the analyzing step comprises selecting, based upon the compared user responses, from among the prior and modified tasks to generate and store a set of related tasks of a workflow for future assignment across different provider groups.

20. The method of claim 1, wherein the prioritized set of tasks are displayed in order of relative priority of time sensitivity or user-specific completion time.

21. A computer-readable storage device storing instructions which, when executed by a computing device, cause the computing device to perform a method comprising:
selecting stored task data identifying multiple related tasks of a workflow for completion by multiple healthcare providers from different provider groups;
assigning different related tasks of the workflow to different assigned users each associated with a different one of the multiple healthcare providers;
generating a prioritized set of assigned tasks for each respective assigned user;
communicating each prioritized task set to the respective assigned user of the associated healthcare provider via an interactive electronic display that allows the assigned user to view the prioritized set and input responses for completing each assigned task;
monitoring the cumulative responses of the assigned users to determine completion of the related tasks of the workflow;
deleting from the prioritized task sets, tasks that are determined completed; and
dynamically reprioritizing the task sets for each of the assigned users based on the monitored user responses and deleted tasks and communicating the updated reprioritized task sets to the respective assigned users of the associated healthcare providers.

22. A healthcare provider task management system comprising:
a processor adapted to electronically communicate with a storage module, a task management module, and an interface module;
the storage module storing appointment, patient, provider and task data relating to patient office visits with healthcare providers;
the task management module comprising a rules engine for processing the stored data, at regular or varying time intervals, to generate a set of prioritized tasks for an associated provider for completion by an assigned user, including:
a task generator for processing the stored data to generate tasks required for completion, including associating stored patient, provider and appointment data with a related task to facilitate completion of the task, and assigning each task one of multiple task types and a task priority;
a task assignment and dispatch module configured to generate a set of prioritized tasks for an associated provider for completion by an assigned user;
the interface module being configured to generate an interactive electronic user interface for displaying the set of prioritized tasks, arranged by task type and priority, to enable the assigned user to access and manage the prioritized tasks, and for accepting user responses for completion of each task;
the task management module further including a task monitor configured to monitor, receive and process the user responses by detecting the timing, content or lack of user responses and update the stored data based on the processed responses; and
wherein, at each subsequent time interval, the task management module processes the updated stored data to generate an updated set of prioritized tasks for display to the assigned user by adding or reprioritizing uncompleted tasks and removing completed tasks.

23. The system of claim 22, wherein the task management module is configured to generate the set of prioritized tasks based on one or more of:
response time;
completion time;
tasks completed by an assigned user in a designated time interval;
tasks having one or more of the same task type or priority or in the same set;
updated appointment, patient or provider data; and
user response from a set of pre-determined user responses.

24. The system of claim 22, wherein each task has one or more of an assigned response time, completion time, reminder time, and reassignment time.

25. The system of claim 22, wherein the task management module is configured to reassign the task to one or more other users if no response is received from the initially assigned user within a predetermined response time assigned to the task, or if the task remains uncompleted after a predetermined completion time assigned to the task.

26. The system of claim 22, wherein the task comprises one or more of confirming an office appointment, providing patient check-in information, providing provider profile information, providing available office appointment information, and confirming patient or provider insurance information.

27. The system of claim 22, wherein the task management module is configured to update the set of prioritized tasks at longer or shorter time intervals based on one or more of: user response time, lack of user response, task completion time, or lack of task completion.

28. The system of claim 22, wherein the task management module is configured to generate an updated set of prioritized tasks for an associated provider based on collective user responses for that provider.

29. The system of claim 22, wherein the task management module is configured to generate an updated set of prioritized tasks based on collective responses for multiple providers of a provider group.

30. A non-transitory computer-readable medium containing instructions to control a processor to perform steps of:
processing, via a rules engine, appointment data relating to patient office visits with healthcare providers at provider facilities, wherein the processing generates tasks associated with such visits;
assigning a priority to each task based on a desired patient experience or provider efficiency;
generating, at regular or varying time intervals, a set of prioritized tasks for an associated provider and assigning the set to an assigned user for completion;
generating a display of the set of prioritized tasks, via an interactive user interface, to enable the assigned user to access and manage the prioritized tasks, and to accept user responses for completing the tasks;
monitoring, receiving and processing the user responses by detecting the timing, content or lack of user responses; and
modifying the set of prioritized tasks based on the processed user responses and generating a display on the user interface of the modified set of prioritized tasks.
